(19) United States
(12) Patent Application Publication
(10) Pub. No.: US 2012/0011541 A1
(43) Pub. Date: Jan. 12, 2012

(54) Systems and Methods for Delivering Additional Content Utilizing a Virtual Channel

(75) Inventor: Michael Joseph McCarthy, Marietta, GA (US)

(73) Assignee: COX COMMUNICATIONS, INC., Atlanta, GA (US)

(21) Appl. No.: 12/834,366

(22) Filed: Jul. 12, 2010

(51) Int. Cl. H04N 7/10; H04N 7/025

(52) U.S. Cl. 725/35; 725/32

(57) ABSTRACT

Embodiments of the invention include systems and methods for delivering additional content utilizing a virtual channel. According to one embodiment, a method for delivering additional content to a viewer is provided. The method may include: associating at least one virtual channel with additional content, wherein the additional content comprises one of: one or more on-demand assets or an on-demand portal designating one or more on-demand assets. The method may further include: delivering initial content to a viewer and providing advertisement content including instructions for accessing the virtual channel or channels. The method may then include: receiving an upstream command from a viewer indicating a virtual channel and halting delivery of the initial content and delivering the additional content associated with the virtual channel indicated to the viewer system responsive to the receipt of the upstream command.

### FIELD OF THE INVENTION

Aspects of the invention relate generally to distribution networks, and more particularly, to systems and methods that facilitate delivering additional content.

### BACKGROUND OF THE INVENTION

Content distribution networks (also referred to interchangeably herein as “distribution networks”), such as cable, satellite, and Internet Protocol (IP) networks, provide a unique means to target advertising to consumers, as well as to present significant amounts of information, both in breadth and depth. In addition, the increasing use of on-demand programming allows viewers to select desired programming according to their own specific interests and schedules.

Accordingly, there exists a need to more effectively utilize the on-demand delivery techniques to present additional information and content to viewers, while increasing the ease by which viewers access the additional information and content. Therefore, a need exists for delivering additional content utilizing an on-demand network and specially assigned channels.

### BRIEF DESCRIPTION OF THE INVENTION

Some or all of the above needs and/or problems may be addressed by certain embodiments of the invention. According to one embodiment, a method for delivering additional content to a viewer is provided. The method may include: associating at least one virtual channel with additional content, wherein the additional content comprises one of: one or more on-demand assets or an on-demand portal designating one or more on-demand assets. The method may further include: delivering initial content to a viewer and providing advertisement content including instructions for accessing the virtual channel or channels. The method may then include: receiving an upstream command from a viewer indicating a virtual channel and halting delivery of the initial content and delivering the additional content associated with the virtual channel indicated to the viewer system responsive to the receipt of the upstream command.

According to another embodiment, a system for delivering additional content to a viewer is provided. The system may include: a network operator system in communication with a viewer system associated with a viewer over a distribution network. The network operator system may be operable to: receive initial content and additional content, wherein the initial content comprises linear broadcast content or on-demand content, and wherein the additional content comprises one of: one or more on-demand assets or an on-demand portal designating one or more on-demand assets; and store an association between the additional content and one or more virtual channels. The network operator system may further be operable to: deliver the initial content to the viewer system over the distribution network; receive an upstream command over the broadcast network from the viewer system indicating one of the virtual channels. In response to the upstream command and request to view the virtual channel, the network operator system may also be operable to halt delivery of the initial content and deliver the additional content associated with the virtual channel indicated to the viewer system.

According to yet another embodiment, a system for delivering additional content to a viewer is provided. The system may include: a network operator system providing a campaign management and mapping module, an on-demand module, and a broadcast module. The on-demand module may be operable to: store one or more on-demand assets or one or more on-demand portals; and cause delivery of one or more on-demand assets or one or more portals over a distribution network to a viewer system. The campaign management and mapping module may be operable to create an association between advertisement content, additional content, and one or more virtual channels, wherein the additional content comprises one or more of the on-demand assets or one or more on-demand portals stored by the on-demand module. The broadcast module may be operable to: cause delivery of initial content over the distribution network to the viewer system; combine the advertisement content with virtual channel information; and cause delivery of the advertisement content combined with virtual channel information over the distribution network to the viewer device. Responsive to receipt of an upstream command indicating one of the one or more virtual channels over the distribution network from the viewer device, the on-demand module may be operable to: perform a look-up by the virtual channel to identify the additional content associated with the virtual channel based on an association therebetween; halt delivery of the initial content; and deliver the additional content associated with the virtual channel to the viewer system.

Additional systems, methods, apparatus, features, and aspects may be realized through the techniques of various embodiments of the invention. Other embodiments and aspects of the invention are described in detail herein with reference to the description and to the drawings and are considered a part of the claimed invention.

### BRIEF DESCRIPTION OF THE DRAWINGS

Reference will now be made to the accompanying drawings, which are not necessarily drawn to scale, and wherein:

FIG. 1 is a block diagram depicting an example system, according to an example embodiment.

FIG. 2 is a block diagram depicting example operations and corresponding data flows, according to an example embodiment.

FIG. 3. is a flow diagram depicting an example method for associating additional content, advertisement content, and virtual channel information, according to an example embodiment.

FIG. 4 is a flow diagram depicting an example method for delivering content utilizing a virtual channel, according to an example embodiment.

### DETAILED DESCRIPTION

Embodiments of the invention now will be described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

Embodiments described herein include systems and methods for delivering additional content over a content distribution network, such as over a cable broadcast network, a satellite broadcast network, or an IP network. Content providers currently utilize on-demand storage and delivery systems provided by network operators to deliver content to viewers at the viewer's request, which may be referred to generally as “non-linear content” or “on-demand content.” According to various embodiments described herein, a network operator system can simplify the means by which on-demand content is accessed by a viewer, minimizing the number of steps (e.g., deep menu navigation) called for to access the on-demand content. To do so, on-demand assets or on-demand portals (collectively referred to herein as “additional content”) can be associated with “virtual channels.” “Virtual channels” are channels reserved for delivering on-demand assets or on-demand portals, which can be easily re-assigned to different assets or portals by virtue of the simple association created between the two.

In conventional systems, for example, some content distribution systems allow delivery of additional content from within an initial content stream, such as by utilizing conventional “telescoping” techniques. However, these telescoping techniques require interactive programming applications to be created and distributed with content and also require more complex back-office processing to render and deliver the telescoped content, including hard-coding assets to interactive programming calls. The embodiments described herein eliminate the need to generate complex interactive programming and hard-coding assets to programming calls, by simply assigning assets to virtual channels, and subsequently utilizing the channel delivery and on-demand delivery techniques to deliver the additional content.

According to one embodiment, a network operator system can identify multiple on-demand assets and/or on-demand portals that designate one or more on-demand assets and associate each asset or portal with a respective virtual channel. By being associated with a virtual channel, a viewer can directly request the on-demand asset or directly navigate to the on-demand portal without being required to navigate an electronic programming guide (EPG), as would otherwise conventionally occur. Conventionally, on-demand assets are accessed by a viewer navigating an EPG hierarchy and selecting the desired asset at the lowest level of the EPG. Upon selecting the desired asset, an interactive application program (e.g., Enhanced TV Binary Interchange Format (EBIF), etc.) is processed at the viewer's device and issued over the distribution network to request delivery of the associated asset. According to embodiments described herein, however, by directly entering a virtual channel number, a viewer can skip the cumbersome navigation of the EPG and directly access the on-demand asset or a specific on-demand portal designating multiple on-demand assets.

By mapping on-demand assets or on-demand portals directly with virtual channel numbers, a network operator can more effectively market the use of its on-demand capabilities to content providers, advertisers, and marketers. Because assets associated with a virtual channel are not hard-coded according to conventional on-demand asset allocation techniques, the network operator can periodically, and with ease, change the mapping of a virtual channel to an asset or portal, such that a particular virtual channel is only mapped to an asset or portal for a predetermined period of time. Thus, content providers, advertisers, and/or marketers (or any other entity desirous of associating additional content with advertisement content utilizing the virtual channel functionality) can quickly and easily request different content be mapped to one or more virtual channels according to their different advertisement campaigns. In return, the network operator can respond by simply changing the association of the virtual channel(s) with the respective on-demand assets desired. This virtual channel arrangement allows easy implementation of a short-term advertisement campaign with an on-demand asset or assets associated with a virtual channel, and after time changing the advertisement campaign and the asset mapping with the virtual channel.

For example, in use, according to one embodiment, an advertiser (e.g., with or on behalf of a content provider) may generate an advertisement to be played with traditional broadcast content, which is also referred to herein interchangeably as “initial content.” The advertisement promotes the availability of additional content and the virtual channel number with which the additional content (e.g., via an on-demand asset or on-demand portal) is associated. The network operator system combines the advertisement with the initial content, combines an overlay (or otherwise indicates) the respective virtual channel number, and transmits it to the viewer in conventional fashion.

Upon viewing the advertisement, the viewer may enter the virtual channel by entering the virtual channel number on a remote control device or executing an interactive programming application (e.g., EBIF, etc.), for example. In response to transmitting the upstream command indicating the virtual channel number from the viewer's system (e.g., from the viewer's set-top box, etc.), the network operator system resolves the mapping between the virtual channel indicated and the additional content, and distributes the additional content (e.g., from an on-demand server system) over the network to the viewer. If the additional content is an on-demand asset, the asset may be immediately played or may request instructions or confirmation from the viewer. If the additional content is an on-demand portal, the portal, which may be configured as a sub-menu of the EPG, is displayed to receive subsequent viewer commands in conventional manner. For example, an on-demand asset may be directly utilized when delivering content such as a movie or television show (e.g., pay-per-view, etc.), while an on-demand portal may be desired if the advertisement is utilized to present options or multiple components of information to the viewer (e.g., product information on multiple products by the same advertiser, etc.). According to one embodiment, an on-demand portal may include multiple mappings between on-demand assets and multiple respective virtual channels, such that the same features of calling the virtual channel are utilized once within the on-demand portal. In another embodiment, or in combination with the aforementioned implementations, an on-demand portal may include one or more on-demand assets that are accessible utilizing conventional on-demand techniques. After viewing the additional content, the viewer may continue by navigating back to the initial content being viewed or within an on-demand portal or EPG.

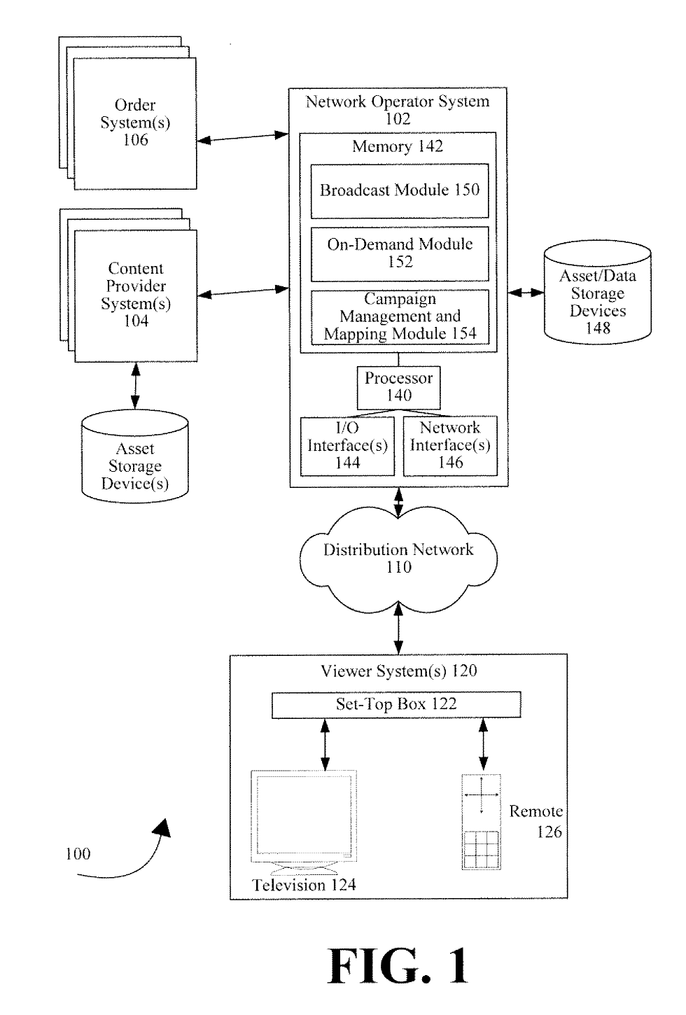

More details regarding the various means for implementing the embodiments of the invention are provided below with reference to FIGS. 1-4.

### System Overview

An example system 100 will now be described illustratively with respect to FIG. 1. The system 100 may include one or more network operators and associated network operator systems 102, one or more content providers and associated content provider systems 104, one or more order systems 106, and one or more distribution networks 110. In addition, the system 100 includes one or more viewer systems 120 in communication with a network operator system 102 via the distribution network 110. Each of the aforementioned systems or system components is configured for accessing and reading associated computer-readable media having data stored thereon and/or computer-executable instructions for implementing the various methods described herein. By executing computer-executable instructions, each of these computer systems may form a special purpose computer or a particular machine. As used herein, the term “computer-readable medium” may describe any form of computer memory or memory device.

The network operator system 102 illustrated in FIG. 1 represents any system or systems comprising one or more computers or other processor-based devices for implementing various functions provided by the respective network operator. It is appreciated that a network operator system 102 may represent a multiple-system operator (MSO), or other distribution network operator, and may logically include operations performed in part by the network plant, the headend, and/or any other component or device of a conventional network operator system. Accordingly, the network operator system 102 may include one or more processor-driven devices, such as, but not limited to, a server computer, a personal computer, and the like. In addition to having one or more processors 140, the network operator system 102 may also further include one or more memories 142, one or more input/output (I/O) interfaces 144, and one or more network interfaces 146. The memory 142 may store data files and various program modules, such as an operating system (OS), a client and/or host module, and a database management system (DBMS) for accessing one or more databases, such as one or more asset or other data storage devices 148. The asset or other data storage devices 148 may be operative for storing on-demand assets and associated information, on-demand portal configuration and information, virtual channel mappings, EPG information, viewer account information, billing information, and/or other information accessible by the network operator system 102 and utilized to provide linear and/or non-linear or on-demand broadcasting, as well as implementing the operations described herein. The I/O interface(s) 144 may facilitate communication between the processor 140 and various I/O devices, such as a keyboard, mouse, printer, microphone, speaker, monitor, and the like. The network interface(s) 146 may take any of a number of forms, such as, but not limited to, a network interface card, a modem, a wireless network card, and the like. In one embodiment, network interfaces 146 may include network system hardware, software, and/or firmware operable to provide content and other data transmission through the distribution network 110, such as over an in-band or an out-of-band media channel with a viewer device (e.g., a set-top box 122 and/or television 124), and/or receive content, advertisement, and campaign information over the same network, or a different network, such as the Internet or any other public or private communications network.

The network operator system 102 may include a broadcast module 150, an on-demand module 152, and a campaign management and mapping module 154. The broadcast module 150, on-demand module 152, and campaign management and mapping module 154 are represented in FIG. 1 as separate components; however, it is appreciated that these components may represent logical functions implemented by a single physical device or may be provided, at least in part, by one or more separate physical devices.

The broadcast module 150 may include computer-executable instructions providing programming logic to distribute audio/video content (e.g., linear broadcast programming) over the distribution network 110 to a viewer system 120 (e.g., to a set-top box 122, etc.), which may be responsive to a viewer's selection or other request therefor. The linear broadcast programming may include advertisement content, such as may be provided by a content provider, or an advertising or marketing entity, to advertise additional content and identify a corresponding virtual channel to view the additional content. The broadcast module 150 may be operable to splice or otherwise insert or distribute the advertisement content with the linear (or non-linear) broadcast programming. In addition to inserting the advertisement content within the broadcast programming, the broadcast module 150 may be further operable to combine an overlay (or otherwise insert into the content stream) instructions including how to request the additional content via the virtual channel (e.g., “To view this [additional content], enter channel [virtual channel] with your remote” or “To view this [additional content], select [“A”] with your remote,” etc.). It is appreciated that the broadcast module 150, and/or another component of the network operator system 102, may be operable to perform other conventional media content distribution functions not specifically described herein. Moreover, the broadcast module 150 and the network operator system 102 may be configured for distributing media over other distribution networks 110 other than cable networks, such as, but not limited to, a satellite broadcast network or an IP network, according to various example embodiments.

The on-demand module 152 may likewise include computer-executable instructions providing programming logic to resolve requests for on-demand assets and to distribute on-demand assets over the distribution network 110 to a viewer system. The on-demand module 152 may therefore access and retrieve on-demand assets from the asset or other data storage device 148 for the distribution of on-demand assets. It is appreciated that the on-demand module 152 may distribute on-demand content operatively with the campaign management and mapping module 154, as discussed herein, or as per conventional on-demand distribution.

The campaign management and mapping module 154 may likewise include computer-executable instructions providing programming logic to facilitate receiving and coordinating advertisement campaign information and data, virtual channel mapping, asset storage, and responding to requests for additional content via a virtual channel request, according to the various embodiments described herein. For example, the campaign management and mapping module 154 may facilitate receiving requests for associating on-demand assets, advertisement campaigns, and advertisement content with virtual channels from an order system 106, and maintaining the mappings between advertisement campaigns, on-demand assets and portals and virtual channels. In addition, the campaign management and mapping module 154 may operatively coordinate with the on-demand module 152 to distribute the on-demand assets and on-demand portals requested via virtual channels. In one embodiment, the campaign management and mapping module 154 may further facilitate distribution of advertisement and/or virtual channel information by one or more marketing channels using a different communication means than over the distribution network, such as, but not limited to, mail, email, Internet advertisement, telecommunications (e.g., telephone, wireless telephone, text messaging, multimedia messaging, etc.), and the like.

It is appreciated that the network operator system 102 may be further configured to perform additional operations not described in detail herein, such as those operations typically performed to distribute linear content and/or non-linear content.

The content provider system(s) 104 represent any system or systems comprising one or more computers or other processor-based devices for implementing various functions provided by or on behalf of content providers. Content providers may include any entity that provides content for delivering via linear or non-linear distribution over the distribution network 110 by the network operator system 102. Content providers can include, but are not limited to, production studios, national media networks, local media networks, and the like. It is appreciated, however, that other types of content providers (e.g., music providers, software providers, e-book providers, etc.) may also be included. Accordingly, a content provider system 104 is operable to provide content to the network operator system 102 for delivery to viewers. The content may be provided as a linear stream (such as if provided by a media network), or may be provided as individual assets (such as if provided by a movie or television production studio), for example, on-demand assets. On-demand assets may be stored and operated on by the on-demand module 152 and the asset or data storage device 148. As discussed above, the on-demand assets from content providers may be utilized as additional content assets that are mapped to one or more virtual channels for delivery to a viewer in response to a viewer's selection, as further described herein. However, it is appreciated that not all on-demand assets are distributed via the virtual channel functionality, but instead may be distributed according to conventional on-demand techniques. The content provider systems 104 may be in communication with the network operator system 102 via any communications network, such as, but not limited to, a private wired or wireless network or a public wired or wireless network (e.g., the Internet, etc.).

The order system(s) 106 represent any system or systems comprising one or more computers or other processor-based devices for implementing various functions associated with receiving advertisement campaign information and additional content information, and providing the same to the network operator system 102. An order system 106 may be operated by or on behalf of a respective network operator system 102, and provide an interface accessible by other entities desirous of implementing a virtual channel marketing campaign. For example, the order system 106 may be accessible over a private wired or wireless network or a public wired or wireless network (e.g., the Internet, etc.). In another embodiment, an order system 106 is provided by one or more third-party entities, such as one or more marketing or advertising entities and/or one or more content providers, each of which are operable for communication with the network operator system 102. Example entities that may utilize the order system 106 are entities that coordinate advertising or marketing campaigns for themselves, or on behalf of other entities (e.g., advertising or marketing agencies, content providers, etc.) and/or content providers that desire to utilize the virtual channel features to provide access to some or all of their on-demand content (e.g., studios, media networks, etc.).

Information collected by the order system 106 is provided to the network operator system 102 to associate a marketing campaign with respective additional content, including, but not limited to: asset identifiers, asset information, campaign identifiers, campaign information, campaign/asset run time, advertisement content, responsible or associated entity information, and the like. In response, the network operator system 102 associates one or more virtual channels that are available for the run time/date with the asset or assets or portals identified and with the advertisement campaign identified. The association between campaign, advertisement content, additional content, and virtual channels enables distributing the appropriate on-demand asset or portal when the virtual channel is requested by viewers, as well as notifying the appropriate associated entities when advertisements are distributed to viewers and when assets are distributed to and accessed by viewers.

With reference to the viewer system 120, one or more viewer devices may optionally be provided, such as a set-top box 122, a television 124 (or other display, such as a personal computer and monitor in an IP network, or a projector and screen, etc.), or a remote control device 126. As used herein, the term “viewer device” refers generally to any one or a combination of set-top boxes 122, televisions 124, other displays, or any other devices operable and configured to present linear and/or non-linear (e.g., on-demand) content to a viewer.

A set-top box 122 may be any suitable device configured to connect to a television 124 or other display and an external source of a signal over a distribution network 110. For example, the set-top box 122 may be a cable set-top box, a cable card, a gateway device, a combination modem and set-top device, a digital satellite set-top box, or an Internet protocol television (IPTV) set-top box operatively configured to communicate with a corresponding network operator system 102 (e.g., a cable network operator, a satellite network operator, an over-the-top IP network content distributor/operator, etc.) over a corresponding distribution network 110 and to convert the received signals into signals capable of displaying audio/video content by a television 124 or other display to a viewer. In one embodiment, the set-top box 122 is adapted to connect to and communicate with a television 124 or other display, as well as to receive command signals from one or more remote control devices 126, which may be a conventional remote control device or any other user device programmed and operable for communicating directly or via an intervening device with the set-top box 122, such as wirelessly (e.g., infrared, Bluetooth, radio frequency, etc.).

The set-top box 122 may be a multipurpose computing device having one or more processors, memories, and input/output (I/O) interfaces in communication. The set-top box 122 may also include a video processor for processing and providing digital and analog audio/video signaling to a television 124 or other viewer devices, an operating system, and a tuner operable for processing audio/video and/or data with the network operator system 102. The set-top box 122 may pass digital and analog audio/video content and/or data to a television 124 that is received from the distribution network 110 via an audio/video and/or data downlink (e.g., an in-band downlink, or an out-of-band downlink, respectively). The set-top box 122 may include computer-executable instructions that provide programming to facilitate the display of content, instructions, and special features, to facilitate the receiving and processing of viewer commands issued via a remote control device 126, for example, and to transmit or otherwise communicate with the network operator system 102 over the distribution network 110 (or any other communications network) to process commands and requests. In one embodiment, the set-top box 122 (or other viewer device), includes programming instructions to execute interactive programming applications (e.g., EBIF, etc.) received as part of the content stream and selected by a remote control device 126, which, in some instances, causes one or more commands to be transmitted upstream to the network operator system 102. Example programming includes, but is not limited to, facilitating the display of advertisement overlays, special instructions, and the like, which may be used to present virtual channel numbers and instructions, advertisement and product or service information to the viewer, and facilitating the receipt of a viewer's selections of one or more commerce commands associated with the selection of a virtual channel (e.g., if selected via an interactive programming menu) for transmission to the network operator system 102 via the distribution network 110 (e.g., via an up-link).

In other embodiments, a set-top box 122 may not be provided, such as where another viewer device is used (e.g., a television 124 adapted for direct communication with a distribution network 110, or a personal computer and display adapted for communication over a distribution network 110 such as an IP network). It is appreciated that the aforementioned examples of viewer devices and network adaptability are provided for illustrative purposes only, and that any other distribution network viewer device may be used with the system 100.

The distribution network 110 may include any number of telecommunication and/or data networks, whether public, private, or a combination thereof, including one or more conventional broadband distribution networks, such as a fiber optic network, a telephone network, an existing cable television broadcast network (e.g., fiber network, coaxial network, a hybrid fiber-coaxial network, etc.), a satellite broadcast network, an IP network, and the like, which are operable to support transmission according to various media/content and transmission protocols (e.g., MPEG 2, ISO 13818-1, etc.). The distribution network 110 may support downstream, upstream, and/or bi-directional communications. Due to network connectivity, various methodologies described herein may be practiced in the context of distributed computing environments. Although the system 100 is shown for simplicity as including one intervening distribution network 110, it is to be understood that any other network configuration is possible, which may optionally include a plurality of networks, each with devices such as gateways and routers, for providing connectivity between or among networks.

Although not described or illustrated in detail, each content provider system 104 and each order system 106 may be configured in the same or similar manner as described for the network operator system 102. In addition, the system 100 shown in and described with respect to FIG. 1 is provided by way of example only. Numerous other operating environments, system architectures, and device configurations are possible. Accordingly, embodiments of the invention should not be construed as being limited to any particular operating environment, system architecture, or device configuration.

### Operational Overview

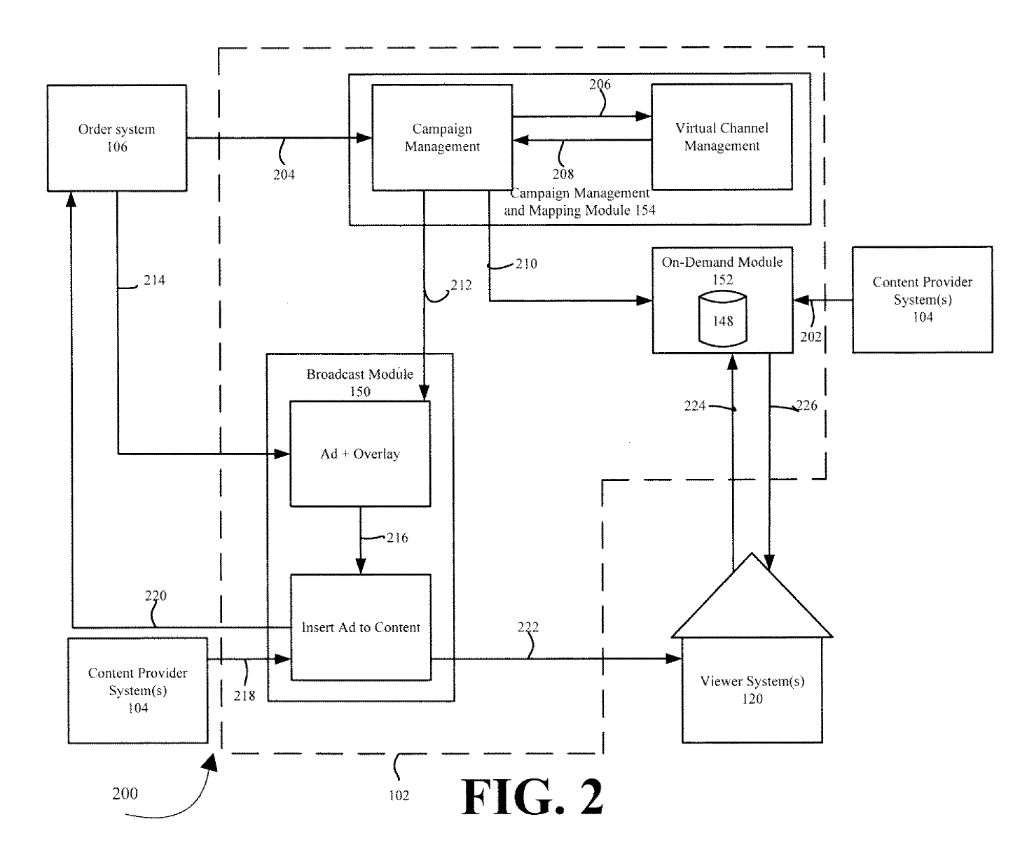

FIG. 2 illustrates a block diagram 200 representing illustrative data flows and operations for presenting additional content utilizing virtual channels, according to an example embodiment. According to one example embodiment, a content provider system 104 provides 202 content to the network operator system 102, which may be received and stored via the on-demand module 152 and the asset or other data storage device 148. The content provided 202 may include additional content to be subsequently advertised to viewers and accessed via one or more virtual channels, such as one or more on-demand assets and/or one or more on-demand portals designating one or more additional on-demand assets. In addition, the content provided 202 to the on-demand module 152 may further include other on-demand content that is to be distributed to viewers according to conventional on-demand delivery techniques.

An order system 106 may be utilized by a marketing entity, advertisement entity, content provider, or any other entity desirous of distributing additional content via a virtual channel. The order system 106 facilitates the gathering of “campaign information,” which is used herein to refer generally to any information utilized in the implementation of distributing additional content via one or more virtual channels. Campaign information may include, but is not limited to, an on-demand asset identifier (e.g., identifying the additional content), other asset information (e.g., asset title, asset summary, asset length, ratings, etc.), asset run time/date (e.g., the period during which the asset is to be offered for viewing), asset owner, advertisement content identifier, advertisement content information, advertisement campaign identifier, campaign entity information, and the like. This campaign information is transmitted 204 to the network operator system 102, such as to the campaign management and mapping module 154, to be utilized for associating advertisement content, additional content, and virtual channels. Upon receipt 204 of the campaign information, the campaign management and mapping module 154 requests 206 that one or more virtual channels be reserved and allocated to the additional content to be distributed according to the campaign information received for as long as the run time/date indicates. In response, the selected virtual channel numbers are transmitted 208 for association with the campaign information. For example, in a simple case, if a campaign has a single asset to be run for one week as additional content, a single virtual channel will be reserved by the campaign management and mapping module 154 for one week during the indicated asset run time/date and the number transmitted 208 for association.

Upon associating all of the campaign information, including the virtual channel number or numbers, the campaign management and mapping module 154 transmits 210 the campaign information, or at least a subset thereof, to the on-demand module 152 to provide an association to the on-demand module 152 between the virtual channel reserved and the additional content to be distributed from the virtual channel (e.g., on-demand asset or on-demand portal). According to one embodiment, at least the virtual channel number, asset identifier, and run time/date are transmitted to the on-demand module 152; though, in other embodiments, additional campaign information may be transmitted (such as to facilitate further data storage, reporting, and/or notifications).

The campaign management and mapping module 154 also transmits 212 a virtual channel overlay to the broadcast module 150, according to one embodiment. The broadcast module 150 may then include the overlay with the corresponding advertisement content provided, which may be provided 214 via the order system 106, or by any other entity in communication with the network operator system 102 (e.g., from the advertiser or marketer entity directly, from a content provider, etc.). According to various embodiments, a virtual channel overlay may be any display overlay (e.g., one of many layers to be delivered in a content stream) that provides instructions to viewers on how to select the virtual channel (or otherwise respond to the advertisement) when viewing. An example overlay may include a region that displays textual instructions over or along with the advertisement content being simultaneously displayed, such as, but not limited to: “To view this [additional content], enter channel [virtual channel] with your remote” or “To view this [additional content], select [“A”] with your remote,” the latter being provided with an interactive programming application (e.g., EBIF, etc.). According to another embodiment, instead of an overlay, virtual channel instructions may be embedded directly within the advertisement content. It is appreciated that the virtual channel overlay may be generated, at least in part, by the network operator system 102, or it may be provided, at least in part, by an outside entity (e.g., advertiser, marketer, content provider, etc.).

As stated, the actual advertisement content may be provided 214 to the network operator system 102 via the order system 106, or directly from another entity. According to one embodiment, the advertisement content may be any audio and/or video content, such as, but not limited to, a short form advertisement to be spliced or otherwise included in linear broadcast content. In another embodiment, however, the advertisement content may be embodied as an on-demand asset, accessible via an EPG or other conventional on-demand delivery technique, such that when viewing the on-demand advertising that is associated with additional content supplied via a virtual channel, a viewer may be presented virtual channel instructions (e.g., a virtual channel overlay) and may select the virtual channel to view the additional content described by the on-demand advertisement content. It is appreciated that, according to various embodiments, advertisement content, and thus advertisement campaigns, may advertise more than one on-demand asset, each of which may be associated with an individual virtual channel. According to one embodiment, the advertisement content describes the additional content. According to various embodiments, the additional content may be related to, but is not limited to, free content, pay-per-view content, movie content, television programming content, music or other audio content, product information, sales information, marketing information, travel, tourism, or other geography-based information, entertainment programming (e.g., interactive games, etc.), political spots, financial services information, industry-specific information, and the like. It is appreciated that the aforementioned examples are provided for illustrative purposes only and are not intended to be limited.

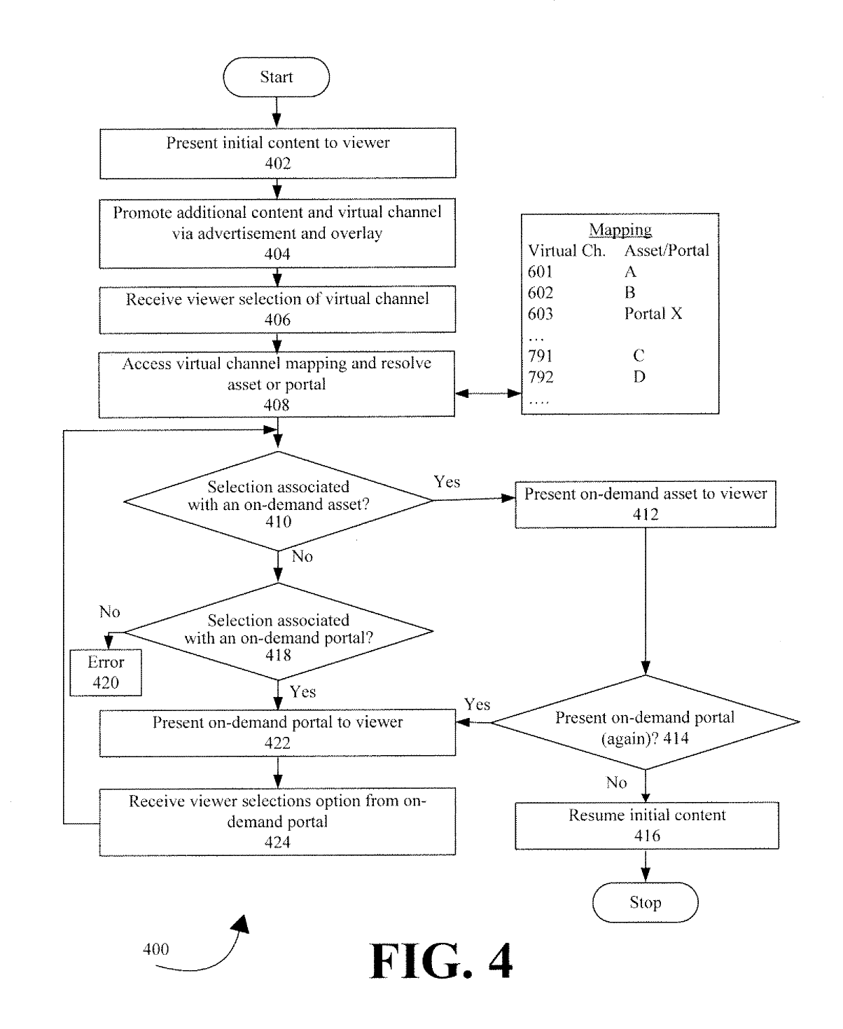

After applying the virtual channel overlay (or other virtual channel instructions) to the advertisement content, the combination is transmitted 216 for splicing the advertisement content and the overlay into an initial content stream provided 218 by a content provider system 104, according to one embodiment. The term “initial content” is used herein to refer generally to broadcast content delivered to a viewer via any conventional means, within which advertisement content advertising additional content accessible via one or more virtual channels may be inserted. According to various embodiments, initial content may be a linear broadcast, or a non-linear broadcast (e.g., on-demand content) provided by any number of content providers. It is appreciated that the type of content into which advertisement content and virtual channel instruction overlays are provided is not intended to be limiting. Moreover, as described in more detail with reference to FIG. 4, advertisement content need not be distributed via the distribution network 110, but may instead, or additionally, be distributed utilizing one or more additional communication means.

At or near the same time the advertisement content is spliced into the initial content stream, a notification 220 may also be transmitted back to the entity responsible for the advertisement campaign (or any other entity associated with the advertisement campaign and/or the additional content displayable via a virtual channel). FIG. 2 illustrates the notification 220 being transmitted via the order system 106; however, it is appreciated that, according to various other embodiments, the notification 220 may be transmitted directly to any other entity, and need not be transmitted via the order system 106. Sending this notification 220 allows the entity or entities associated with the advertisement campaign to track the number of times the advertisement was broadcast. In addition, this notification 220 (or a similar notification) may be utilized by the network operator system (or any other entity) to track revenue that may be generated as a result of broadcasting advertisement content.

Accordingly, after the advertisement content is included with the initial content stream, the network operator system 102 broadcasts 222 the content over the distribution network 110 to viewer systems 120, according to conventional broadcasting techniques. Upon viewing the advertisement content and virtual channel overlay, a viewer who wishes to view the additional content may select the virtual channel according to the overlay instructions. For example, if the advertisement content and overlay includes an interactive programming application (e.g., EBIF, etc.), then a user may simply make an on-screen selection with a remote. The viewer system 120, such as a set-top box appropriately programmed, will process the interactive programming application, change the tuning of the set-top box to issue an up-stream command 224 to the on-demand module 152 of the network operator system 102 over the distribution network 110. In another embodiment, in which the advertisement content and overlay do not include an interactive programming application but simply include instructions for the viewer to enter the virtual channel, upon entry of the virtual channel by the viewer, an up-stream command 224 will be issued over the distribution network 110. The upstream command 224 will indicate the virtual channel selected by the viewer, which is, in turn, associated with the additional content advertised by the advertisement content.

In response to the up-stream command 224, the on-demand module 152 retrieves the additional content that was previously associated with the virtual channel by the campaign management and mapping module 154 from the asset or other data storage device 148. As described, the additional content may be an on-demand asset or may be an on-demand portal presenting a sub-menu or menus from which one or more on-demand assets may be selected for viewing. The additional content is then delivered 226 back to the viewer system 120 over the distribution network 110 for viewing. Upon viewing the additional content, any number of operations may be performed. In one embodiment, the initial content that was being presented to the viewer is resumed. In another embodiment, the viewer may be returned to an on-demand menu that allows viewing yet further on-demand assets that may (or may not) be related to the additional content just viewed.

Accordingly, by presenting advertisements that allow a viewer to directly, conveniently, and quickly access additional content, a viewer's experience is improved and an advertiser's or content provider's effectiveness of delivering the additional content is enhanced, while also likely increasing the number of views.

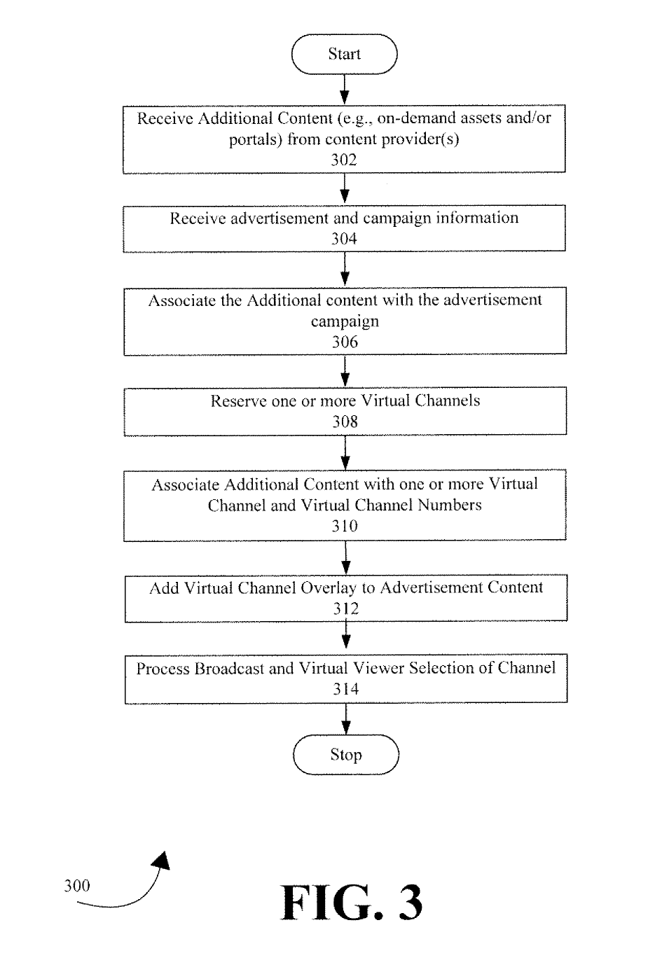

FIG. 3 represents a flow diagram of an example method 300 for receiving campaign information and additional content, and associating this information and content with one or more virtual channels, according to one embodiment. In one embodiment, the method 300 is performed by a network operator system 102, such as by one or more of an on-demand module 152 and/or a campaign management and mapping module 154. The method may begin at block 302, in which additional content (e.g., one or more on-demand assets and/or one or more on-demand portals) is received from one or more content provider systems 104 (or other entity). According to this example, for illustrative purposes, the additional content is specific to a marketing campaign provided by an advertiser entity. At block 304, advertisement campaign information and advertisement content, such as is described above with reference to FIG. 2, is received. The advertisement campaign information may be provided by the same entity that provides the content at block 302 (e.g., by a content provider), or it may be provided by another entity, such as an entity working with or on-behalf of the content provider (e.g., an advertising entity, marketing entity, third-party service provider, etc.). Next, at block 306, the network operator system 102 stores an association between the additional content and the campaign information, which creates an initial association or “mapping” between the content and the campaign.

In addition, at blocks 308 and 310, a virtual channel is reserved for each additional content to be made available to the viewer, and the virtual channel(s) are associated with the campaign and content information, respectively. For example, according to one embodiment, the network operator system 102 may have a certain predefined number of available channels designated for use as virtual channels. These virtual channels, however, are frequently assigned and re-assigned to different content, according to the advertisement campaign demands. Thus, only available channels for the time indicated by the campaign information can be reserved for each asset associated with the campaign. Upon reserving the necessary number of virtual channels at block 308, which prevents associating the channels with other content, an association is created between the campaign information (e.g., the asset identifier, the campaign identifier, the advertisement content identifier, etc.) and the virtual channel and/or virtual channel number. As shown in FIG. 2, this association may be transmitted to an on-demand module 152 of the network operator system 102 to facilitate future retrieval and distribution of the on-demand asset or portal when the virtual channel number is selected by a viewer.

At block 312, a virtual channel overlay is added to the advertisement content prior to distributing the initial content and advertisement content to a viewer, as described in more detail with reference to FIG. 2. Finally, at bock 314, the network operator system 102 broadcasts the advertisement content with the initial content and responds to a viewer's selection of a virtual channel to view the additional content, which is described in more detail with reference to FIG. 4.

The method 300 may end after block 314, having mapped campaign information, advertisement information, on-demand asset information, and virtual channel numbers to permit the subsequent processing of virtual channel requests.

FIG. 4 represents a flow diagram of an example method 400 for presenting initial content combined with advertisement content to allow viewer selection of a virtual channel to view additional content associated with the virtual channel, according to one embodiment. The method 400 may begin at block 402, in which initial content is presented to a viewer, such as to a viewer system 120 over a distribution network 110, as described above. As part of the initial content stream, at block 404, advertisement content coupled with a virtual channel overlay (or other means of including virtual channel instructions) is embedded and delivered to a viewer system 120 with the initial content. As discussed herein, the advertisement content may describe or otherwise encourage the viewer to view or otherwise access additional content (e.g., an on-demand asset or an on-demand portal making available multiple on-demand assets). The additional content is associated with a virtual channel, as described with reference to FIGS. 2-3, for example. Thus, the virtual channel overlay presents instructions along with the advertisement content describing how a viewer can select a virtual channel.

It is appreciated that, according to other embodiments, instead of, or in addition to, including advertisement content in a broadcast stream over a distribution network, advertisement content may be transmitted according to any number of various other techniques, including, but not limited to, mail, email, Internet advertisement, telecommunications (e.g., telephone, wireless telephone, text messaging, multimedia messaging, etc.), and the like. Advertisement content transmitted utilizing these different channels of communication may still include information about the additional content available for viewing, as well as information indicating the virtual channel number or numbers that provide direct access to the additional content. In addition, the advertisement content may further include additional campaign information, such as the run time/date, the time period during which the additional content will be available via the virtual channel(s). For example, a cable company's customers may receive a promotional email describing available new releases from a certain production studio, and provide instructions to enter virtual channel numbers during certain dates to directly access and view the new releases.

At block 406, the network operator system 102 may then receive a viewer's selection of the virtual channel identified at block 404 by the virtual channel overlay. The viewer may manually enter the virtual channel number with a remote control device, or the viewer may utilize an interactive programming application to select an on-screen option (e.g., utilizing EBIF, or other application transmitted with the advertisement content and overlay). The virtual channel number may be transmitted from the viewer system 120 to the network operator system via an upstream command over the distribution network 110, for example.

Upon receiving the viewer's selection, at block 408, the network operator system, such as the on-demand module 152, accesses a virtual channel for additional content mapping, such as is provided by the operations described with reference to FIG. 3, for example. As is shown in FIG. 4, some virtual channels (e.g., 601, 602, 791, 792, as shown) may be associated with a single on-demand asset (e.g., as indicated by “A,” “B,” “C,” “D,” respectively), while other virtual channels (e.g., 603, as shown) may be associated with an on-demand portal (e.g., as indicated by “Portal X”). In one embodiment, an on-demand portal may further be associated with additional on-demand assets that are likewise assigned to different virtual channels (e.g., virtual channels 791, 792 mapped to assets “C” and “D,” as shown), such that on-demand assets accessible by an on-demand portal may likewise be accessible by a direct entry of the virtual channel. For example, a content provider, advertiser entity, or marketing entity may want to have certain additional content only accessible from an on-demand portal, while others are accessible directly from a user entry of a virtual channel. Accordingly, at block 408, the network operator system resolves via a mapping look-up which on-demand asset or on-demand portal is to be delivered to the viewer system based on the virtual channel sent via an upstream command from the viewer at block 406.

At decision block 410, it is determined whether an on-demand asset is to be delivered to the viewer system 120 based on the mapping look-up performed at block 408. If the mapping look-up indicates an on-demand asset is to be presented, then block 412 follows. At block 412, the on-demand asset is presented to the viewer over the distribution network 110 via conventional on-demand delivery techniques. It is appreciated that additional communications may be exchanged between the viewer system 120 and the network operator system 102 at this point, such as to confirm viewing, confirm a pay-per-view asset, and the like.

Following block 412, are blocks 414 and 416, by which the on-demand programming logic may provide for an on-demand portal (or other EPG menu) to be presented to the viewer or that the initial content being viewed by the viewer resumes. Accordingly, if it is determined at decision block 414 that an on-demand portal (or other EPG menu) is to be presented, operations continue to present an on-demand menu (or other EPG menu) as described below with reference to blocks 418-424. Otherwise, if it is determined at decision block 414 that the initial content is to be resumed, then block 416 follows, in which the network operator system halts on-demand delivery and resumes delivering the initial content stream delivered at block 402.

According to one embodiment, at block 416 the initial content is resumed at or near the point in the initial content stream where it was halted to present the additional content. This action may be performed by initiating a DVR session at the viewer system 120 to record the initial content upon issuing the upstream command to view the virtual channel. Thus, by recording the initial content stream while viewing the additional content, when resuming the initial content at block 416, the initial content can be viewed from the DVR recording instead of from a broadcast stream. It is appreciated, however, that, in other embodiments, the initial content may be resumed at some later point in the content stream by broadcast delivery, such that at least a portion is missed by the viewer while viewing the additional content.

If, however, at decision block 410 it is determined that an on-demand portal is to be initially presented instead of an on-demand asset (e.g., an on-demand portal is associated with the virtual channel number selected), then blocks 418-424 follow. At decision block 418, it is confirmed whether an on-demand portal is associated with the virtual channel number selected. If not, then an error is generated at block 420, which may cause initial programming to resume, or present additional selections to the viewer for responding to the error to resolve the selection, as desired. It is appreciated, however, that some or all of the operations at decision block 418 need not be performed, or may not include or otherwise be apparent to the viewer. For example, the method 400 may continue after decision block 410 to block 422 directly.

At block 422, the on-demand portal associated with the virtual channel number is delivered to the viewer system 120. As described herein, the on-demand portal may be any menu or series of menus (e.g., an EPG) that allows selection of one or more on-demand assets for delivery to the viewer. According to various embodiments, the on-demand portal may have only a single level, indicating one or more on-demand assets upon initial access, or may have multiple levels of hierarchy, whereby each level may present one or more on-demand assets and/or one or more sub-menus for selection by the viewer. Also as described herein, some of the on-demand assets identified in the menu may additionally have a virtual channel number associated with them and be optionally displayed, allowing the viewer to directly enter the virtual channel number to access the on-demand asset, even when within the menu. At block 424, the network operator system 102 receives the viewer's selection from the on-demand portal, which may be an on-demand asset or another sub-menu. After selection, operations continue to decision block 410 to process the viewer's selection in the same or similar manner as the original selection to determine whether to present an on-demand asset or an on-demand portal or sub-menu. Accordingly, operations repeat until the desired additional content has been viewed or when the viewer manually selects to exit the on-demand programming or the system causes the viewer to exit.

The method 400 may therefore end after block 416 (or upon any other exit from the programming), having promoted additional content to a viewer viewing initial content and delivering the additional content using traditional on-demand delivery techniques, while giving the viewer easy and efficient access directly to the additional content via one or more virtual channels.

Accordingly, by mapping on-demand assets and/or on-demand portals directly with virtual channel numbers, a network operator can more effectively market the use of its on-demand capabilities to content providers, advertisers, and marketers. Moreover, because assets associated with a virtual channel are not hard-coded to be called directly utilizing conventional on-demand asset allocation, the network operator can periodically, and with ease, change the mapping of an asset or portal to a virtual channel, such that the asset or portal can be provided via a virtual channel for only a predetermined period of time. Thus, content providers, advertisers, and/or marketers (or any other entity desirous of associating additional content with advertisement content utilizing the virtual channel features) can quickly and easily request different content be mapped to one or more virtual channels according to their different advertisement campaigns. The network operator can respond by simply changing the association of the virtual channel(s) with the respective on-demand assets desired. This virtual channel arrangement allows easy implementation of a short-term advertisement campaign by associating an on-demand asset or assets with a virtual channel. After time, the campaign can modify the asset mapping with the virtual channel.

### Illustrative Examples

To present one illustrative example, the virtual channel operations may be utilized by a production studio to advertise multiple featured movies (e.g., new releases, certain genre, etc.). Accordingly, the production studio would provide the featured movies as on-demand assets to the network operator system 102, which may be embodied as pay-per-view assets or free assets, as desired. In addition, the production studio, or an advertising or marketing entity on its behalf, provides campaign information to the network operator system 102, such as via an order system 106. The campaign information can include an identifier of the featured movies (and/or titles of the movies), an identifier of the advertisement campaign (which may otherwise be generated by the network operator system 102), a run time/date schedule for running the corresponding advertisement and making available the featured movies, an identifier of the featured movie owner (e.g., an identifier of the production studio), and advertisement content to encourage viewing of the featured movies. In addition, because the advertisement campaign is associated with multiple featured movies, according to one embodiment, the offering may be configured as an on-demand portal providing a listing of the available featured movies, which may also be included in the campaign information. The network operator system 102, in turn, generates a virtual channel mapping by reserving a virtual channel for each of the featured movies (e.g., for each on-demand asset to be delivered if requested) and/or a virtual channel for an on-demand portal, and subsequently generating and storing an association between the campaign information, the advertisement content, the virtual channel, and the on-demand assets. A virtual channel overlay may be generated by the network operator system 102 and/or by the content provider (or advertising or marketing entities), for display with the advertisement content.

During the appropriate campaign run time/date, the network operator system 102 splices the advertisement content with the overlay into a conventional broadcast, such as during the broadcast of conventional linear content to a viewer system 120 over a distribution network 110. Therefore, a viewer, while watching the linear broadcast, may see the advertisement and select a virtual channel indicated in the advertisement content to view the associated featured movie. For example, the advertisement content may play a trailer for each movie while the overlay indicates a different virtual channel number associated with each featured movie. In another example, the overlay may indicate a single virtual channel number, which is associated with an on-demand portal that then lists each of the featured movies as being selectable by a viewer according to conventional on-demand delivery techniques.

According to one embodiment, a network operator may generate revenue by charging fees according to the number of times a virtual channel is accessed, whether it directly causes delivery of an on-demand asset or display of an on-demand portal. Thus, in one instance, an on-demand portal designating multiple assets within the portal may be more cost effective for the content provider/marketer/advertiser because it can more efficiently navigate a user to multiple assets, while still making available multiple on-demand assets. However, in other embodiments, fees may likewise be charged for any on-demand assets accessed via an on-demand portal irrespective of whether they are accessed directly via a virtual channel or via an on-demand portal that was accessed via a virtual channel.

As another illustrative example, the virtual channel operations may be utilized by a product manufacturer (e.g., an automotive manufacturer) to advertise multiple products (e.g., new vehicle models). Accordingly, the automotive manufacturer would likely utilize an advertising or marketing entity to coordinate its marketing campaign and facilitate the utilization of the virtual channel functionality. An advertising or marketing entity would therefore provide the content for each of the new models being advertised (e.g., informational and/or promotional audio/video content) as on-demand assets to the network operator system 102. In addition, the advertising or marketing entity would provide advertisement content and on-demand portal configuration information to the network operator system 102. In response, the network operator system 102 would reserve a virtual channel and create a mapping between the campaign information, the advertisement content, the virtual channel, and the on-demand portal. Accordingly, in this example, only the on-demand portal is associated with the virtual channel, and the on-demand assets providing information about the new models are accessed by viewers from the on-demand portal according to conventional on-demand delivery techniques.

During the appropriate campaign run time/date, the network operator system 102 splices the advertisement content with the overlay into a conventional broadcast over a distribution network 110. A viewer may thus see the advertisement for the new models and select the virtual channel indicated in the advertisement to navigate directly to the on-demand portal. Once within the on-demand portal, each of the on-demand assets is selectable by a viewer according to conventional on-demand delivery techniques. Therefore, according to this example, an advertising or marketing entity can easily advertise its new models from a single advertisement, while providing convenient and easy access to additional, more detailed information for each of the new models as on-demand assets.

It is appreciated that the preceding examples are provided for illustrative purposes and are not intended to be limiting. According to various other embodiments, any type of content may be promoted or otherwise made available utilizing the virtual channel functionality. In addition, any combination of the virtual channel features described herein, and any variation of on-demand assets and/or on-demand portal configurations may be utilized.

Various block and/or flow diagrams of systems, methods, apparatus, and/or computer program products according to example embodiments are described above. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, or may not necessarily need to be performed at all, according to some embodiments.

These computer-executable program instructions may be loaded onto a special purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks. As an example, embodiments of the invention may provide for a computer program product, comprising a computer usable medium having a computer-readable program code or program instructions embodied therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special purpose hardware and computer instructions.

Many modifications and other embodiments of the invention set forth herein will be apparent having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

The claimed invention is:

1. A method for delivering additional content to a viewer, comprising:
associating, at a network operator system comprising one or more computers, at least one virtual channel with additional content, wherein the additional content comprises one of: one or more on-demand assets or an on-demand portal designating one or more on-demand assets;
delivering, by the network operator system over a distribution network to a viewer system, initial content;
providing advertisement content including instructions for accessing the at least one virtual channel;
receiving, at the network operator system from the viewer system, an upstream command indicating a virtual channel; and
halting delivery of the initial content to the viewer system and delivering, by the network operator system, the additional content associated with the virtual channel indicated to the viewer system responsive to the receipt of the upstream command, wherein viewing the additional content does not incur an additional fee to the viewer.

2. The method of claim 1, wherein the additional content comprises at least one of: (a) an on-demand asset providing advertisement content; or (b) an on-demand asset providing informational content.

3. The method of claim 1, wherein the additional content comprises at least one of: (a) an on-demand movie; (b) an on-demand television show; or (c) on-demand entertainment content.

4. The method of claim 1, wherein the additional content comprises an on-demand portal designating a plurality of on-demand assets, and wherein delivering the additional content comprises delivering the on-demand portal to the viewer system for viewing and selecting at least one of the plurality of on-demand assets designated by the on-demand portal.

5. The method of claim 4, wherein the upstream command comprises a first upstream command and further comprising:
receiving a second upstream command from the viewer system indicating one of the plurality of on-demand assets designated by the on-demand portal; and
in response to receiving the second upstream command, delivering the one of the plurality of on-demand assets indicated by the second upstream command.

6. The method of claim 5, wherein the on-demand portal is associated with a first virtual channel, and wherein at least one of the plurality of on-demand assets designated by the on-demand portal is associated with a second virtual channel, and wherein the second upstream command indicates the second virtual channel.

7. The method of claim 4, wherein the plurality of on-demand assets relate to a same category of content.

8. The method of claim 1, wherein the additional content comprises a plurality of on-demand assets, each on-demand asset associated with a different virtual channel.

9. The method of claim 1, wherein the at least one virtual channel is promoted to the viewer by one or more of: (a) virtual channel information embedded within the initial content; (b) virtual channel information embedded within the advertisement content; or (c) virtual channel information provided by an overlay presented with the advertisement content.

10. The method of claim 1, wherein the advertisement content comprises at least one of: (a) broadcast advertisement delivered within the stream of initial content; (b) on-demand advertisement content accessible via an on-demand delivery system; or (c) non-broadcast and non-on-demand content.

11. The method of claim 1, wherein the initial content comprises one of: (a) linear broadcast content; or (b) on-demand content.

12. The method of claim 1, further comprising:
receiving campaign information at the network operator system; and
associating the additional content and the at least one virtual channel with the campaign information.

13. The method of claim 1, wherein the additional content is temporarily associated with the at least one virtual channel.

14. The method of claim 13, wherein associating the at least one virtual channel with the additional content comprises re-associating the at least one virtual channel from a previous on-demand asset or on-demand portal to a different on-demand asset or on-demand portal.

15. The method of claim 1, wherein the additional content is to be associated with the at least one virtual channel for a predefined period of time.

16. The method of claim 15, wherein providing the advertisement content including instructions for accessing the virtual channel is provided during the predefined period of time.

17. The method of claim 1, further comprising, upon receipt of the upstream command indicating the virtual channel, performing a look-up by the virtual channel to identify the additional content to be presented, wherein the network operator system comprises a stored association between the virtual channel and the additional content.

18. The method of claim 1, wherein the upstream command is received responsive to one of: (a) entry by the viewer of a channel number associated with the virtual channel; (b) entry by the viewer of a remote control entry associated with the virtual channel; or (c) a selection by the viewer of a menu selection presented via the viewer system, wherein the menu selection is associated with the virtual channel.

19. The method of claim 1, further comprising, after presenting the additional content to the viewer system, continuing to present the initial content to the viewer system.

20. The method of claim 19, wherein the initial content is resumed approximately where halted to present the additional content.

21. The method of claim 19, wherein the initial content is resumed at some later point than where halted to present the additional content.

22. A system for delivering additional content to a viewer, comprising:
a network operator system comprising at least one memory storing computer-executable instructions and at least one processor operable to execute the computer-executable instructions, the network operator system in communication with a viewer system associated with a viewer over a distribution network;
wherein the processor is operable to execute the computer-executable instructions to:
receive initial content and additional content, wherein the initial content comprises linear broadcast content or on-demand content, and wherein the additional content comprises one of: one or more on-demand assets or an on-demand portal designating one or more on-demand assets;
store an association in the at least one memory between the additional content and one or more virtual channels;
deliver the initial content to the viewer system over the distribution network;
receive an upstream command over the broadcast network from the viewer system indicating one of the one or more virtual channels; and
halt delivery of the initial content to the viewer system and deliver the additional content associated with the virtual channel indicated to the viewer system responsive to the receipt of the upstream command, wherein viewing the additional content does not incur an additional fee to the viewer.

23. The system of claim 22, wherein the additional content comprises at least one of: (a) an on-demand asset providing advertisement content; or (b) an on-demand asset providing informational content.

24. The system of claim 22, wherein the additional content comprises at least one of: (a) an on-demand movie; (b) an on-demand television show; or (c) on-demand entertainment content.

25. The system of claim 22, wherein the additional content comprises an on-demand portal designating a plurality of on-demand assets, wherein the upstream command comprises a first upstream command resulting in delivery of the on-demand portal; and wherein, after delivering the on-demand portal, the processor is further operable to execute the computer-executable instructions to:
receive a second upstream command from the viewer system indicating one of the plurality of on-demand assets designated by the on-demand portal; and
in response to receiving the second upstream command, deliver the one of the plurality of on-demand assets indicated by the second upstream command.

26. The system of claim 22, wherein the one or more virtual channels are promoted to the viewer by one or more of: (a) virtual channel information embedded within the initial content; (b) virtual channel information embedded within advertisement content delivered over the distribution network; (c) virtual channel information provided by an overlay presented with advertisement content distributed over the distribution network; or (d) non-broadcast and non-on-demand content.

27. The system of claim 22, wherein the processor is further operable to execute the computer-executable instructions to re-associate the one or more virtual channels from a previous on-demand asset or on-demand portal to a different on-demand asset or on-demand portal.

28. A system for delivering additional content to a viewer, comprising:
a network operator system comprising at least one memory storing computer-executable instructions and at least one processor operable to execute the computer-executable instructions, the computer-executable instructions providing: a campaign management and mapping module, an on-demand module, and a broadcast module;
the on-demand module operable to: store one or more on-demand assets or one or more on-demand portals; and cause delivery of one or more on-demand assets or one or more on-demand portals over a distribution network to a viewer system;
the campaign management and mapping module operable to create an association between advertisement content, additional content, and one or more virtual channels, wherein the additional content comprises one or more of the one or more on-demand assets or one or more on-demand portals stored by the on-demand module;
the broadcast module operable to: cause delivery of initial content over the distribution network to the viewer system; combine the advertisement content with virtual channel information; and cause delivery of the advertisement content combined with virtual channel information over the distribution network to the viewer device;
wherein, responsive to receipt of an upstream command indicating one of the one or more virtual channels over the distribution network from the viewer device, the on-demand module is operable to: perform a look-up by the virtual channel to identify the additional content associated with the virtual channel based on an association therebetween; halt delivery of the initial content over the distribution network to the viewer system; and deliver the additional content associated with the virtual channel over the viewer network to the viewer system, wherein viewing the additional content does not incur an additional fee to the viewer.
